(19) United States
(12) Patent Application Publication
(10) Pub. No.: US 2013/0078445 A1
(43) Pub. Date: Mar. 28, 2013

(54) Foam Composition and Method of Making Same

(71) Applicants: Natarajan S. Ramesh, Grapevine, TX (US); Emanuel M. DaSilva, East Falmouth, MA (US)

(72) Inventors: Natarajan S. Ramesh, Grapevine, TX (US); Emanuel M. DaSilva, East Falmouth, MA (US)

(73) Assignee: Sealed Air Corporation, Cryovac, Div., Duncan, SC (US)

(21) Appl. No.: 13/240,445

(22) Filed: Sep. 22, 2011

(51) Int. Cl. B32B 5/20; C08L 33/06; C08L 33/02; C08L 3/00; C08L 23/08; C08L 31/02; C08L 23/12; C08L 23/14; C08J 9/14; C08L 23/06

(52) U.S. Cl. 428/220; 521/73; 521/75

(57) ABSTRACT

A foam comprises (a) starch, (b) plasticizer, (c) compatibilizer, and (d) polyolefin selected from one or more of ethylene homopolymer, ethylene/alpha-olefin copolymer, ethylene/vinyl ester of aliphatic carboxylic acid copolymer, propylene homopolymer, and propylene copolymers. The ratio of A to B is at least 0.01, where A is the sum of the weights of components (a) and (b), and B is the sum of the weights of components (a) though (d). The foam may have a density of at most 10 pounds/cubic foot.

### BACKGROUND

The presently disclosed subject matter relates to foams comprising starch and polyolefin, for example, extruded foam sheets and plank comprising starch and polyolefin.

In producing foams incorporating polyolefin and the renewable feedstock of plasticized starch, difficulty may be encountered in that the surface of the extruded foam may “corrugate”—that is, present an undesirable wavy surface appearance. This problem becomes particularly problematic as the amount of plasticized starch in the foam increases and/or as the density of the foam decreases. Further, it is desirable to provide a foam incorporating plasticized starch without significant degradation of the foam strength properties.

### SUMMARY

One or more embodiments disclosed herein may address one or more of the aforementioned problems.

In an embodiment of the disclosed subject matter, a foam comprises (a) starch, (b) plasticizer, (c) compatibilizer, and (d) polyolefin selected from one or more of ethylene homopolymer, ethylene/alpha-olefin copolymer, ethylene/vinyl ester of aliphatic carboxylic acid copolymer, propylene homopolymer, and propylene copolymers. The foam has a density of at most 10 pounds/cubic foot. The ratio of A to B is at least 0.01, where A is the sum of the weights of components (a) and (b), and B is the sum of the weights of components (a) though (d).

In another embodiment of the disclosed subject matter, the foam may be made by providing and mixing the starch, the plasticizer, the compatibilizer, the polyolefin, and a physical blowing agent in an extruder to form a mixture, followed by expanding the mixture to form the foam as the mixture exits the extruder.

These and other objects, advantages, and features of the disclosed subject matter will be more readily understood and appreciated by reference to the detailed description.

### DETAILED DESCRIPTION

The foams of the presently disclosed subject matter comprise starch, plasticizer, compatibilizer, and polyolefin, as discussed herein.

The foams of various embodiments disclosed herein may be extruded in various forms, as discussed herein. For example, the foam may take the form of a sheet (e.g., plank) having a thickness of at least any of 0.015, 0.03, 0.08, 0.10, 0.20, 0.15, 0.3, 0.4, 0.8, 1, 1.5, and 2 inches; and/or at most any of 5, 4, 3, 2, 1, 0.8, 0.4, 0.3, 0.20, 0.15, and 0.1 inches. In industry the term “sheet” typically refers to a relatively thin web of foam that is typically inherently somewhat flexible because its thickness is relatively thin; and the term “plank” typically refers to a relatively thick web of foam that is typically inherently somewhat rigid because its thickness is relatively thick. However, for convenience sake, the term “sheet” when used generally herein is considered as including a “plank” configuration, and a thicknesses range will be recited to distinguish thicknesses rather than relying on the terms “plank” and “sheet” for thickness distinctions. The sheet (e.g., plank) may have an aspect ratio (i.e., width in the transverse direction divided by the thickness) of at least, and/or at most, any of the following: 10; 20; 100; 500; 1,500; 1,600; and 2,500. The foam may take the form of an extruded rod configuration having a diameter corresponding to any of the previously recited thicknesses and ranges of thicknesses.

The foams of various embodiments disclosed herein may have a density of at least any of 0.5, 0.8, 1.0, 1.5, 2, 3, 4, 5, 6, and 7 pounds/cubic foot; and/or at most any of 10, 9, 8, 7, 6, 5, 4, 3, 2, 1.0, and 0.8 pounds/cubic foot. Density of the foam is measured according to ASTM D3575. Further, the foam may have any of the recited densities in combination with any of the above recited thicknesses.

### Starch and Plasticizer

The foams of the presently disclosed subject matter comprise starch and plasticizer. Since starch on its own exhibits poor thermoplastic processing properties, the starch is plasticized by melt processing it with one or more plasticizers to form a plasticized starch (having the starch and plasticizer as constituent parts). These components may be provided to the extruder in the form of plasticized starch, or the starch and plasticizer may be provided separately and combined during extrusion mixing to create plasticized starch during the extrusion.

Starch in its various forms is well known in the art, comprising various amounts of amylose and/or amylopectin forms of starch. Useful starch includes corn starch (i.e., starch derived from corn), potato starch, wheat starch, soybean starch, and tapioca starch.

The starch useful for one or more of the foam embodiments may comprise chemically modified starch, such as oxidized starch, etherificated starch, esterified starch, crosslinked starch, or starch having such chemical modifications combined. Chemically modified starch typically has hydroxyl groups reacted with one or more reagents. The degree of substitution associated with the reaction ranges from 0 (for native starch) up to 3 (fully substituted chemically modified starch). Useful etherificated starches include those having hydroxyl groups substituted with ethyl and/or propyl groups. Useful esterified starches include those having hydroxyl groups substituted with acetyl, propanoyl, and/or butanoyl groups. For example, the starch may comprise starch acetate having a degree of substitution (DS) of at least 0.1.

Useful plasticizers for the foams of the presently disclosed subject matter include polyhydric alcohols, such as one or more of any of the following: glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5hexanediol, 1,2,6-hexanetriol, 1,3,5-hexanetriol, neo-pentyl glycol, trimethylol propane, pentaerythritol, mannitol, sorbitol, and the acetate, ethoxylate, and propoxylate derivatives thereof. For example, the foam may comprise glycerol and/or sorbitol as plasticizer.

The amount of plasticizer may be at least any of the following: 5, 10, 15, 25, 35, 45, 50 weight parts; and/or at most any of the following: 60, 50, 40, 35, 30, 25, 20, 15, and 10 weight parts, relative to 100 weight parts starch.

The amount of starch and plasticizer (e.g., plasticized starch) in the foams of the presently disclosed subject matter may be characterized as the ratio of “A” to “B,” where “A” is the sum of the weights of the starch and plasticizer components in the foam and “B” is the sum of the weights of the starch, plasticizer, compatibilizer, and polyolefin in the foam. The ratio of A to B may be at least any of 0.01, 0.03, 0.04, 0.05, 0.08, 0.10, 0.15, and 0.20; and/or at most any of 0.04, 0.05, 0.08, 0.10, 0.15, 0.20, and 0.22.

### Compatibilizer

A compatibilizer in the context of the present disclosure is a polymeric additive that modifies the interface between blended immiscible starch and polyolefin polymers to stabilize the blend. Starch and polyolefin are normally incompatible in a blend because starch (and plasticized starch) are relatively hydrophilic, while petrochemical-derived materials such as polyolefins are typically relatively hydrophobic. The compatiblizer stabilizes the dispersion of plasticized starch and polyolefin, for example by reducing the interfacial tension between the plasticized starch domains and the polyolefin domains. The compatibilizer may have a low interfacial tension with the polyolefin, and is preferably partially or fully miscible with the polyolefin.

Useful compatibilizers for the disclosed blends of plasticized starch and polyolefin include polymers having functional groups that interact with starch molecules and/or are capable of chemically bonding with starch functional groups. Examples of functional groups that interact and/or are capable of reacting with starch include carboxyl or carboxylate groups, hydroxyl groups, tertiary amino and/or quaternary ammonium groups, sulfoxyl and/or sulfoxylate groups, and vinyl pyrrolidone copolymers.

Particularly useful compatibilizers include polymers having carboxyl or carboxylate functional groups, such as copolymers of ethylene with (meth)acrylic acid or alkyl(meth)acrylate. Representative examples include: (1) ethylene/(meth)acrylic acid copolymer, which is the copolymer of ethylene and acrylic acid, methacrylic acid, or both, and (2) ethylene/alkyl(meth)acrylate copolymer, which is the copolymer of ethylene and alkyl esters of acrylic or methacrylic acid, where the ester mer groups have from 4 to 12 carbon atoms. Representative examples of the latter include ethylene/methyl acrylate copolymer, ethylene/ethyl acrylate copolymer, ethylene/isobutyl acrylate copolymer, ethylene/n-butyl acrylate copolymer, ethylene/hexyl acrylate copolymer, ethylene/2-ethylhexyl acrylate copolymer, ethylene/methyl methacrylate copolymer, ethylene/ethyl methacrylate copolymer, ethylene/isobutyl methacrylate copolymer, ethylene/n-butyl methacrylate copolymer, ethylene/hexyl methacrylate copolymer, and ethylene/2-ethylhexyl methacrylate copolymer.

The compatibilizers comprising copolymers of ethylene and (meth)acrylic acid or alkyl(meth)acrylate may comprise (meth)acrylic acid comonomer content or alkyl(meth)acrylate comonomer content in the amounts of at least any of 5, 10, 15 wt. %; and/or at most any of 20, 15, and 10 wt. %, based on the weight of the copolymer.

Useful compatibilizers for the presently disclosed foams are also described in U.S. Pat. No. 6,605,657 to Favis et al and WO 2010/131134 A2 to Wang et al published Nov. 18, 2010, each of which is incorporated herein by reference in its entirety.

The amount of compatibilizer in the foams of the presently disclosed subject matter may be characterized by the ratio of “C” to “B,” where “C” is the weight of the compatibilizer in the foam and “B” is the sum of the weights of the starch, plasticizer, compatibilizer, and polyolefin in the foam. The ratio of C to B may be at least any of, and/or at most any of the following: 0.003, 0.005, 0.010, 0.015, 0.02, 0.03, 0.04, 0.05, 0.066, 0.07, 0.08, and 0.10. For example, the ratio of C to B in the foam may be at least 0.005 and at most 0.08.

The presently disclosed foam embodiments may be free of one or more of any of the following classes of polymers: polyvinyl alcohol, polyvinyl acetate, and/or water-soluble polymers. By “water-soluble” is meant that the polymer is appreciably dissolved in water at 20° C. temperature. In this context, “free” allows trace or small amounts of the excluded component to the extent that such amount is insufficient to contribute appreciably to the compatibilizing function.

### Polyolefin

The foams of the presently disclosed subject matter may comprise polyolefins selected from one or more of ethylene homopolymer, ethylene/alpha-olefin copolymer, ethylene/vinyl ester of aliphatic carboxylic acid copolymer (e.g., ethylene/vinyl acetate copolymer), propylene homopolymer, and propylene copolymers.

The term “polyolefins” includes copolymers that contain at least 50 mole % monomer units derived from olefin. Ethylene homopolymers include high-density polyethylene (“HDPE”) and low density polyethylene (“LDPE”). Ethylene copolymers include ethylene/alpha-olefin copolymers (“EAOs”), and ethylene/unsaturated ester copolymers,. (“Copolymer” as used in this application means a polymer derived from two or more types of monomers, and includes terpolymers, etc.)

EAOs are copolymers of ethylene and one or more alpha-olefins, the copolymer having ethylene as the majority mole-percentage content. The comonomer may include one or more C₃-C₂₀ α-olefins, one or more C₄-C₁₂ α-olefins, and one or more C₄-C₈ α-olefins. Useful α-olefins include 1-butene, 1-hexene, 1-octene, and mixtures thereof.

Exemplary EAOs include one or more of the following: 1) medium density polyethylene (“MDPE”), for example having a density of from 0.926 to 0.940 g/cm3; 2) linear medium density polyethylene (“LMDPE”), for example having a density of from 0.926 to 0.940 g/cm3; 3) linear low density polyethylene (“LLDPE”), for example having a density of from 0.915 to 0.930 g/cm3; 4) very-low or ultra-low density polyethylene (“VLDPE” and “ULDPE”), for example having density below 0.915 g/cm3, for example, below 0.905 g/cm3, and 5) homogeneous EAOs. Useful EAOs include those having a density of less than any of the following: 0.925, 0.922, 0.920, 0.917, 0.915, 0.912, 0.910, 0.907, 0.905, 0.903, 0.900, and 0.898 grams/cubic centimeter. Unless otherwise indicated, all densities herein are measured according to ASTM D1505.

The polyethylene polymers may be either heterogeneous or homogeneous. As is known in the art, heterogeneous polymers have a relatively wide variation in molecular weight and composition distribution. Heterogeneous polymers may be prepared with, for example, conventional Ziegler-Natta catalysts.

On the other hand, homogeneous polymers are typically prepared using metallocene or other single-site catalysts. Such single-site catalysts typically have only one type of catalytic site, which is believed to be the basis for the homogeneity of the polymers resulting from the polymerization. Homogeneous polymers are structurally different from heterogeneous polymers in that homogeneous polymers exhibit a relatively even sequencing of comonomers within a chain, a mirroring of sequence distribution in all chains, and a similarity of length of all chains. As a result, homogeneous polymers have relatively narrow molecular weight and composition distributions. Examples of homogeneous polymers include the metallocene-catalyzed linear homogeneous ethylene/alpha-olefin copolymer resins available from the Exxon Chemical Company (Baytown, Tex.) under the EXACT trademark, linear homogeneous ethylene/alpha-olefin copolymer resins available from the Mitsui Petrochemical Corporation under the TAFMER trademark, and long-chain branched, metallocene-catalyzed homogeneous ethylene/alpha-olefin copolymer resins available from the Dow Chemical Company under the AFFINITY trademark.

Another exemplary ethylene copolymer polyolefin is ethylene/vinyl ester of aliphatic carboxylic acid copolymer, which is the copolymer of ethylene and one or more vinyl ester of aliphatic carboxylic acid monomers, where the vinyl esters mer units have from 4 to 12 carbon atoms. Representative examples of the vinyl ester of aliphatic carboxylic acid group of monomers include vinyl acetate, vinyl propionate, vinyl hexanoate, and vinyl 2-ethylhexanoate. The vinyl ester monomer may have any of from 4 to 8 carbon atoms, from 4 to 6 carbon atoms, from 4 to 5 carbon atoms, and 4 carbon atoms.

The vinyl ester of aliphatic carboxylic acid comonomer content of the ethylene/vinyl ester of aliphatic carboxylic acid copolymer may be at least, and/or at most, any of the following: 6, 8, 10, 15, 20, 25, 30, 35, 40, and 45 mole %. For example, the comonomer content may range from at least 6 to at most 20 mole %. Useful ethylene comonomer contents may be at least any of the following: 82, 85, and 88 mole %, and/or at most any of the following: 94, 93, and 92 mole %.

Useful propylene copolymer includes: (1) propylene/ethylene copolymers (“EPC”), which are copolymers of propylene and ethylene having a majority weight % content of propylene, such as those having an ethylene comonomer content of less than 15%, less than 6%, and at least 2% by weight and (2) propylene/butene copolymers having a majority weight % content of propylene.

The amount of selected polyolefin in the foams of the presently disclosed subject matter may be characterized by the ratio of “D” to “B,” where “D” is the total weight of the amount of polyolefins selected from one or more of ethylene homopolymer, ethylene/alpha-olefin copolymer, and ethylene/vinyl ester of aliphatic carboxylic acid copolymer in the foam and “B” is the sum of the weights of the starch, plasticizer, compatibilizer, and polyolefin in the foam. The ratio of D to B in the presently disclosed foams may be at least any of the following: 0.60, 0.65, 0.70, 0.75, 0.80, 0.85, 0.90, 0.92, and 0.94; and/or at most any of the following: 0.98, 0.96, 0.94, 0.92, 0.90, 0.85, 0.80, and 0.70. For example, the ratio of D to B in the foam may be at least 0.70 and at most 0.96.

### Thermoplastic Starch Masterbatch

As mentioned above the starch may be plasticized by melt processing it with one or more plasticizers to form a plasticized starch (having the starch and plasticizer as constituent parts). These components may be provided to an extruder in the form of plasticized starch masterbatch composition (e.g., a composition previously melt processed and subsequently solidified or pelletized), comprising for example the starch, plasticizer, as well as some or all of the compatibilizer, and a portion of the selected polyolefin.

For example, a plasticized starch masterbatch (i.e., thermoplastic starch masterbatch) useful to make the presently disclosed foams may comprise from 5 to 25 wt. % ethylene/alpha olefin copolymer having a density of less than 0.905 g/cm3 (e.g., very low density polyethylene) and from 5 to 25 wt. % ethylene/acrylic acid copolymer, in addition to from 50 to 80 wt. % of starch and plasticizer components, all based on the weight of the thermoplastic starch masterbatch. The thermoplastic starch masterbatch may also comprise from 1 to 10 wt. % ethylene/vinyl acetate copolymer, and/or from 5 to 20 wt. % polyethylene having a density greater than 0.905 g/cm3, based on the weight of the thermoplastic starch masterbatch. Useful thermoplastic starch masterbatch compositions are disclosed, for example, in International Patent Application WO 2010/012041 A1 published Feb. 4, 2010, corresponding to U.S. patent application Ser. No. 13/056,489 to Changping et al filed Jan. 28, 2011, each of which is incorporated herein in its entirety by reference.

### Other Components

The disclosed foams may include one or more of the following components: nucleating agent (e.g., zinc oxide, zirconium oxide, silica, and talc), filler (e.g., calcium carbonate), pigments, colorants, antioxidants, flame retardants, stabilizers, fragrances, odor masking agents, and processing aids, as are known in the art.

The disclosed foams may also comprise one or more permeation modifiers (also known as aging modifiers), such as glycol monostearate, fatty acid ester, fatty acid amide, and hydroxyl amide, which function to help balance the relative permeabilities in the foam of the hydrocarbon blowing agent and air to make the foam dimensionally stable during and after migration of the blowing agent. Such permeation modifiers are disclosed in U.S. Pat. No. 6,005,015 to Ramesh, which is incorporated herein in its entirety by reference.

### Physical Blowing Agent

The feedstock composition for making the presently disclosed foams includes physical blowing agent. A “physical blowing agent” is a blowing agent that does not require a chemical reaction to generate the foaming gas or vapor, the latter being characterized as a “chemical blowing agent.” Physical blowing agents include carbon dioxide, hydrofluorocarbons (HFCs), chlorofluorocarbons, hydrochlorofluorocarbons, nitrogen, acetone, methylene chloride, hydrocarbon blowing agents (i.e., hydrocarbons, such as one or more of the following: ethane, propane, n-butane, isobutane, pentane, hexane, and butadiene), and mixtures thereof. Many physical blowing agents, and in particular hydrocarbon blowing agents, provide the advantage of being dissolvable in the polymeric feedstock under the extrusion conditions provided in extrusion mixing the starch, plasticizer, compatibilizer, and polyolefin—yet flash to vapor upon exposure to ambient pressure when exiting the extruder to foam the mixture.

The blowing agent may be mixed with the feedstock resin of starch, plasticizer, compatibilizer, and polyolefin in the desired amount to achieve a desired degree of expansion in the resultant foam. Generally, the blowing agent may be added to the feedstock resin in an amount of at least any of 0.5 parts, 1 part, 3 parts, and/or at most 80 parts, 30 parts, and 15 weight parts, based on 100 parts by weight of the feedstock resin.

### Process of Making the Foam

In making the of the various embodiments of the present disclosure, the starch, plasticizer, compatibilizer, and polyolefin are added to an extruder, and may be added in the form of resin pellets. As previously mentioned, the starch and plasticizer may be provided separately and combined during extrusion mixing to create plasticized starch during the extrusion, or the starch and plasticizer components may be provided to the extruder in the form of plasticized starch masterbatch composition, comprising for example the starch, plasticizer, as well as some or all of the compatibilizer, and a portion of the selected polyolefin.

The blowing agent may be added to the polymer melt via one or more injection ports in the extruder. Any additives that are used may be added to the polymer melt in the extruder and/or may be added with the resin pellets.

The extruder pushes the entire melt mixture (melted polymer, plasticized starch, blowing agent, and any additives) through a die at the end of the extruder and into a region of reduced temperature and pressure (relative to the temperature and pressure within the extruder). Typically, the region of reduced temperature and pressure is the ambient atmosphere. The sudden reduction in pressure causes the blowing agent to nucleate and expand into a plurality of cells that solidify upon cooling of the polymer mass (due to the reduction in temperature), thereby trapping the blowing agent within the cells.

The extrusion melt and mixing processing is conducted for sufficient time and at a suitable temperature to promote intimate blending of the components. The melt processing is performed within a temperature range suitable for the nature of the polymers being extruded.

The die has a configuration to produce the desired shape and size of the foamed extrudate. The foam may be extruded in the form of relatively thin foam sheet, relatively thick foam plank, and/or rods having circular or other cross-sectional configurations.

Any conventional type of extruder may be used, for example, single screw, double screw, and/or tandem extruders. In the extruder, the resin pellets are melted and mixed.

Processes for making polyolefin foams in general are well known in the art. See, e.g., U.S. Pat. No. 5,348,984 (Lee), U.S. Pat. No. 5,462,974 (Lee), and U.S. Pat. No. 5,667,728 (Lee), each of which is incorporated herein in its entirety by reference. Further disclosure of polyolefin foams and the formulations and methods of making them are in U.S. Pat. Nos. 6,593,386; 6,323,245; 6,773,798; 6,809,125; 6,492,013; 6,462,101; and 6,872,756, each of which is incorporated herein in its entirety by reference.

The following examples are presented for the purpose of further illustrating and explaining the present invention and are not to be taken as limiting in any regard. Unless otherwise indicated, all parts and percentages are by weight.

In the examples, the following abbreviations apply:

“LOPE 1” is a low density polyethylene available from Westlake Corporation under the trade name DA706, having a melt index of 2.2 g/10 minutes (under ASTM D-1238; 2.16 kg/190° C.), and a density of 0.9226 g/cc.

“Recycled LDPE 1” is 100% low density polyethylene including post industrial reprocess and reprocess scrap material.

“TPS MB” is a thermoplastic starch masterbatch available from Cardia Bioplastics Corporation under the Biohybrid BL-F02 trade name, believed to be a homogeneous blend of plasticized starch, polyethylene, and compatibilizer, having a plasticized starch content of 66 wt. %, a density of 1.18 g/cc (ASTM D-792), and a melt flow index of 1.2 g/10 minutes (2.16 kg/190° C.; ASTM D-123 8).

“GMS1” is glycerol monostearate from Caravan Ingredients under the BFP 75A trade name having 54 wt. % monoglyceride content, 1.2 wt. % free glycerine, and 0.6 wt. % free fatty acid, and functioning as permeation modifier.

“GMS2” is glycerol monostearate from Croda Corporation under the ATMER 129 trade name having about 90 wt. % total monoglyceride content, about 1 wt. % free glycerine, and functioning as permeation modifier.

“Talc MB” is a talc masterbatch containing about 25 wt. % talc based on the weight of the masterbatch, sold by Polyfil Corporation under the ABC-2500PB Antiblock Concentrate trade name, and functioning as nucleating agent.

“CF 20” is a sodium bicarbonate and citric acid system as a polyethylene based masterbatch available from Clariant Corporation under the Hydrocerol CF 20 E trade name, functioning as an endothermic chemical foaming and nucleating agent.

“Isobutane” is an isobutane blowing agent.

“Propane” is a propane blowing agent.

“Color MB” is a black color masterbatch available from Techmer.

### EXAMPLES 1-3

Extruded cylindrical rod-shape closed-cell foams were made by blending and extruding the components in the amounts and under the conditions set forth in Table 1. The extruder was a Warner & Pflenderer 30 mm twin-screw extruder having an orifice die.

TABLE 1

| | Sample 1 | Example 1 | Example 2 | Example 3 |
|---|---|---|---|---|
| LDPE 1 (lb/hr) | 14 | 12.88 | 11.76 | 9.8 |
| TPS MB (lb/hr) | 0 | 1.12 | 2.24 | 4.2 |
| Isobutane (lb/hr) | 0.55 | 0.55 | 0.55 | 0.40 |
| Talc MB (lb/hr) | 0.25 | 0.125 | 0.125 | 0.125 |
| GMS1 (lb/hr) | 0.28 | 0.42 | 0.42 | 0.42 |
| Total starch and | 0 | 0.74 | 1.48 | 2.77 |
| plasticizer (lb/hr) | | | | |
| Total starch, plasticizer, | 14 | 14 | 14 | 14 |
| compatibilizer, and | | | | |
| polyolefin (lb/hr) | | | | |
| Ratio of A to B* | 0 | 0.05 | 0.11 | 0.20 |
| TPS MB/(TPS MB + | 0 | 8.0 | 16 | 30 |
| LDPE 1) (wt. %) | | | | |
| Screw speed (rpm) | 126 | 126 | 126 | 126 |
| % Load** | 54 | 60 | 70 | 78 |
| Melt temperature (° C.) | 110 | 108-109 | 106-107 | 113-114 |
| Die pressure (psig) | 560 | 500 | 700 | 600 |
| Foam density (pcf) | 3.66 | 3.51 | 5.13 | 8.68 |
| Foam rod diameter | 1.803 | 1.803 | 1.702 | 1.168 |
| (cm) | | | | |

*“A” is the total weight of starch and plasticizer; “B” is the total weight of starch, plasticizer, compatibilizer, and polyolefin.
**% load is an approximation of the amount of power that the extrusion motor generated to process the foam extrudate compared to the rated power capability of the motor.

There was no corrugation observed on the surfaces of any of the extruded foam rods of Examples 1-3.

### EXAMPLES 4-5

Extruded closed-cell foam planks were made having a thickness of about 2.2 inches and a width of about 48 inches by blending and extruding the following components in the amounts and under the conditions as set forth in Table 2. The extruder was a tandem extruder having two single screw extruders connected in series. The first (primary) extruder melted the resin with additives and mixed the liquid blowing agent into the melt. The second (secondary) extruder continued to mix the blowing agent thoroughly and cooled the melt gradually and in a homogenous manner before expansion upon exiting the flat die. The die distributed the melt uniformly across the cross-section. Due to sudden pressure drop and thermodynamic un-stability, bubbles nucleated and grew due to diffusion of gas into the cells. The expanded foam in the form of thick plank was casted on conveyor for further cooling and testing. The planks were needle punched to ensure exchange of blowing agent with air during curing, thereby ensuring good dimensional stability before testing of physical properties.

The foam was tested for density, compression strength, and percentage compressive creep in accordance with ASTM D3575 test method. Results are given in the following Table 2.

TABLE 2

| | Sample 2 | Example 4 | Example 5 |
|---|---|---|---|
| LDPE 1 (wt. %) | 17.37 | 9.85 | 0 |
| Recycled LDPE 1 (wt. %) | 71.64 | 71.04 | 71.21 |
| TPS MB (wt. %) | 0 | 8.06 | 17.91 |
| Color MB (wt. %) | 0.45 | 0.45 | 0.45 |
| Isobutane (wt. %) | 9.72 | 9.70 | 9.71 |
| GMS1 (wt. %) | 0.73 | 0.72 | 0.72 |
| CF 20 (wt. %) | 0.09 | 0.18 | 0 |
| Total % | 100 | 100 | 100 |
| Total starch and plasticizer | 0 | 5.32 | 11.82 |
| (wt. %) | | | |
| Total starch, plasticizer, | 89.01 | 88.95 | 89.12 |
| compatibilizer, and polyolefin | | | |
| (wt. %) | | | |
| Ratio of A to B* | 0 | 0.06 | 0.13 |
| Extrudate melt temperature | 230.3 | 230.5 | 229.8 |
| (° F.) | | | |
| Die pressure (psig) | 383 | 385 | 354 |
| Foam Density (pcf) | 1.64 | 1.64 | 1.68 |
| Thickness (inches) | 2.21 | 2.21 | 2.17 |
| Cell Count, MD/CMD** | 25/27 | 25/25 | 24/26 |
| Compressive Strength at 25% | 7.4 | 7.2 | 6.9 |
| (psi) | | | |
| Compression Strength at 50% | 13.8 | 13.4 | 13.1 |
| (psi) | | | |
| % Creep | 2.47 | 3.92 | 5.71 |
| % Recovery | 95.2 | 95.3 | 95.7 |

*“A” is the total weight of starch and plasticizer; “B” is the total weight of starch, plasticizer, compatibilizer, and polyolefin.
**“MD/CMD” means machine direction and cross-machine (transverse) direction, respectively.

There was no corrugation observed on the surfaces of any of the extruded foam planks of Examples 4 and 5.

However, an attempt to make comparable foam plank that increased the TPS MB content to 32.2 wt. % (corresponding to 21.25 wt. % total starch and plasticizer) while maintaining the total starch, plasticizer, compatibilizer, and polyolefin content at about 89 wt. % (i.e., a ratio of A to B of about 0.24) resulted in undesirable surface corrugation for the foam plank.

### EXAMPLES 6 to 8

Extruded closed-cell foam sheets were made having a thickness of from 0.039 inches to 0.139 inches and a width of about 72 inches by blending and extruding the following components in the amounts and under the conditions as set forth in Table 3. The extruder was a tandem extruder having two single screw extruders connected in series. The first (primary) extruder melted the resin with additives and mixed the liquid blowing agent into the melt. The second (secondary) extruder cooled the melt gradually and in a homogenous manner before expansion upon exiting the annular die. Due to sudden pressure drop, foam nucleation and sheet expansion occurred in the resulting tubular web. The tubular foam sheet was pulled over the sizing mandrel, slit at the bottom, and then laid flat before reaching a series of rollers for winding into a roll.

The foam was tested for density and other properties, as provided in the following Table 3.

TABLE 3

| | Sample 3 | Example 6 | Example 7 | Example 8 |
|---|---|---|---|---|
| LDPE 1 (lb/hr) | 460 | 460 | 460 | 460 |
| TPS MB (lb/hr) | 0 | 40 | 40 | 40 |
| Isobutane (lb/hr) | 95 | 97 | 0 | 0 |
| Propane (lb/hr) | 0 | 0 | 71 | 71 |
| Talc MB (lb/hr) | 6.6 | 0 | 0 | 0 |
| GMS2 (lb/hr) | 5.06 | 5.06 | 5.52 | 5.52 |
| Total starch and | 0 | 26.4 | 26.4 | 26.4 |
| plasticizer (lb/hr) | | | | |
| Total starch, plasticizer, | 14 | 500 | 500 | 500 |
| compatibilizer, and | | | | |
| polyolefin (lb/hr) | | | | |
| Ratio of A to B* | 0 | 0.05 | 0.05 | 0.05 |
| TPS MB/(TPS MB + | 0 | 8 | 8 | 8 |
| LDPE 1) (wt. %) | | | | |
| Extrudate Melt | 234 | 233.5 | 234.6 | 234.6 |
| temperature (° F.) | | | | |
| Die pressure (psig) | 845 | 765 | 820 | 820 |
| Foam density (pcf) | 0.99 | 0.92 | 0.94 | 1.03 |
| Foam thickness | 0.124 | 0.139 | 0.127 | 0.123 |
| (inches) | | | | |
| Cell Count, MD/CMD | 35/29 | 26/22 | 24/25 | 25/31 |
| Tensile stress MD (psi) | 48.81 | 38.38 | 41.43 | 49.72 |
| Elongation MD (%) | 95.2 | 83.6 | 91.5 | 74.6 |
| Tear Resistance MD | 7.93 | 7.98 | 7.41 | 7.77 |
| (lb/in) | | | | |
| Tensile Stress CMD | 24.65 | 23.39 | 21.91 | 23.99 |
| (psi) | | | | |
| Elongation CMD (%) | 72.3 | 74.9 | 66.5 | 57.5 |
| Tear Resistance CMD | 5.64 | 5.58 | 5.45 | 4.95 |
| (lb/in) | | | | |

*“A” is the total weight of starch and plasticizer; “B” is the total weight of starch, plasticizer, compatibilizer, and polyolefin.

Additional production runs were made using the compositions of Examples 7 and 8 to make foams having thicknesses ranging from as low as 0.039 inches up to 0.108 inches.

Surprisingly, the Examples 6-8 foams had an improvement of cell structure compared to Sample 3, as shown by “finer” cells. This was even more unexpected because Examples 6-8 formulations did not use talc. Accordingly, nucleating agent such as talc may not be required to make relatively thin foam, for example, at thicknesses at or below 125 mils.

### Additional Embodiments

The following sentences describe additional embodiments of the disclosed subject matter.
A. A foam comprising:

(a) starch;

(b) plasticizer;

(c) compatibilizer; and

(d) polyolefin selected from one or more of ethylene homopolymer, ethylene/alpha-olefin copolymer, ethylene/vinyl ester of aliphatic carboxylic acid copolymer, propylene homopolymer, and propylene copolymers;

wherein:

the foam has a density of at most 10 pounds/cubic foot; and

the ratio of A to B is at least 0.01, where A is the sum of the weights of components (a) and (b), and B is the sum of the weights of components (a) though (d).
B. The foam of sentence A wherein the starch comprises chemically modified starch.
C. The foam of any one of the previous sentences wherein the plasticizer comprises polyhydric alcohol, preferably, one or more of any of the following: glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5hexanediol, 1,2,6-hexanetriol, 1,3,5-hexanetriol, neo-pentyl glycol, trimethylol propane, pentaerythritol, mannitol, sorbitol, and the acetate, ethoxylate, and propoxylate derivatives thereof.
D. The foam of any one of the previous sentences wherein the ratio of A to B is at least 0.03, preferably at least any of 0.03, 0.04, 0.05, 0.08, 0.10, 0.15, and 0.20.
E. The foam of any one of the previous sentences wherein the ratio of A to B is at most 0.22, preferably at most any of 0.04, 0.05, 0.08, 0.10, 0.15, and 0.20.
F. The foam of any one of the previous sentences wherein the compatibilizer comprises functional groups selected from one or more of carboxyl, carboxylate, hydroxyl, tertiary amino, quaternary ammonium, sulfoxyl, and sulfoxylate groups.
G. The foam of any one of the previous sentences wherein the compatibilizer comprises vinyl pyrrolidone copolymer.
H. The foam of any one of the previous sentences wherein the compatibilizer comprises one or more copolymers of ethylene with (meth)acrylic acid or alkyl (meth)acrylate.
I. The foam of any one of the previous sentences wherein the ratio of the weight of compatibilizer (c) to the sum of the weights of components (a) though (d) ranges from at least 0.003, preferably at least any 0.005, 0.010, 0.015, 0.02, 0.03, 0.04, 0.05, 0.066, 0.07, and 0.08.
J. The foam of any one of the previous sentences wherein the ratio of the weight of compatibilizer (c) to the sum of the weights of components (a) though (d) ranges from at most 0.10, preferably at most any of 0.005, 0.010, 0.015, 0.02, 0.03, 0.04, 0.05, 0.066, 0.07, and 0.08.
K. The foam of any one of the previous sentences wherein the foam is free of water-soluble polymer.
L. The foam of any one of the previous sentences wherein the foam is free of any one of polyvinyl alcohol or polyvinylacetate.
M. The foam of any one of the previous sentences wherein the ratio of the weight of polyolefin to the sum of the weights of components (a) though (d) is at least 0.6, preferably at least any of 0.65, 0.70, 0.75, 0.80, 0.85, 0.90, 0.92, and 0.94.
N. The foam of any one of the previous sentences wherein the ratio of the weight of polyolefin to the sum of the weights of components (a) though (d) is at most 0.98, preferably at most any of 0.96, 0.94, 0.92, 0.90, 0.85, 0.80, and 0.70.
O. The foam of any one of the previous sentences wherein the foam has a density of at most 9 pounds/cubic foot, preferably at most any of 9, 8, 7, 6, 5, 4, 3, 2, 1.0, and 0.8 pounds/cubic foot.
P. The foam of any one of the previous sentences wherein the foam has a density of at least 0.5 pounds/cubic foot, preferably at least any of 0.8, 1.0, 1.5, 2, 3, 4, 5, 6, and 7 pounds/cubic foot.
Q. The foam of any one of the previous sentences wherein the foam is configured as a sheet having a thickness of at least 0.015 inches, preferably at least any of 0.03, 0.08, 0.10, 0.15, 0.3, 0.4, 0.8, 1, 1.5, and 2 inches.
R. The foam of any one of the previous sentences wherein the foam is configured as a sheet having a thickness of at most any of 5, 4, 3, 2, 1, 0.8, 0.4, 0.3, 0.15, and 0.1 inches.
S. The foam of any one of the previous sentences wherein the foam is configured as a sheet having an aspect ratio of at least 10, preferably at least any of 20; 100; 500; 1,500; 1,600; and 2,500.
T. The foam of any one of the previous sentences wherein the foam is configured as a sheet having an aspect ratio of at most 2,500, preferably, at most any of 20; 100; 500; 1,500; and 1,600.
U. The foam of any one of the previous sentences wherein the polyolefin comprises one or more of high-density polyethylene, low density polyethylene, ethylene/alpha-olefin copolymers, such as one or more of medium density polyethylene, linear medium density polyethylene, linear low density polyethylene, very-low or ultra-low density polyethylene, homogeneous ethylene/alpha-olefin copolymer, ethylene/unsaturated ester copolymers, such as ethylene/vinyl ester of aliphatic carboxylic acid copolymer where the vinyl esters mer units have from 4 to 12 carbon atoms, propylene/ethylene copolymer having a majority weight % propylene comonomer content and propylene/butene copolymers having a majority weight % propylene monomer content.
V. A process for making the foam of any one of the previous sentences comprising:

providing the starch, the plasticizer, the compatibilizer, the polyolefin, and a physical blowing agent to an extruder;

mixing the starch, plasticizer, compatibilizer, polyolefin, and physical blowing agent in the extruder to form a mixture; and

expanding the mixture to form the foam as the mixture exits the extruder.
W. The process of sentence V wherein at least a portion of the starch, plasticizer, and compatibilizer are mixed together before the providing step.
X. The process of sentence W wherein at least a portion of the starch, plasticizer, compatibilizer, and polyolefin are mixed together before the providing step.
Y. The process of any one of sentences V through X wherein the physical blowing agent comprises a hydrocarbon blowing agent.

Any numerical value ranges recited herein include all values from the lower value to the upper value in increments of one unit provided that there is a separation of at least 2 units between any lower value and any higher value. As an example, if it is stated that the amount of a component or a value of a process variable (e.g., temperature, pressure, time) may range from any of 1 to 90, 20 to 80, or 30 to 70, or be any of at least 1, 20, or 30 and/or at most 90, 80, or 70, then it is intended that values such as 15 to 85, 22 to 68, 43 to 51, and 30 to 32, as well as at least 15, at least 22, and at most 32, are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The above descriptions are those of preferred embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference. All references to ASTM tests are to the most recent, currently approved, and published version of the ASTM test identified, as of the priority filing date of this application. Each such published ASTM test method is incorporated herein in its entirety by this reference.

What is claimed is:

1. A foam comprising:
(a) starch;
(b) plasticizer;
(c) compatibilizer; and
(d) polyolefin selected from one or more of ethylene homopolymer, ethylene/alpha-olefin copolymer, ethylene/vinyl ester of aliphatic carboxylic acid copolymer, propylene homopolymer, and propylene copolymers;
wherein:
the foam has a density of at most 10 pounds/cubic foot; and
the ratio of A to B is at least 0.01, where A is the sum of the weights of components (a) and (b), and B is the sum of the weights of components (a) though (d).

2. The foam of claim 1 wherein the plasticizer comprises polyhydric alcohol.

3. The foam of claim 1 wherein the ratio of A to B is at least 0.04 and at most 0.22.

4. The foam of claim 1 wherein the compatibilizer comprises one or more copolymers of ethylene with (meth)acrylic acid or alkyl(meth)acrylate.

5. The foam of claim 1 wherein the ratio of the weight of compatibilizer (c) to the sum of the weights of components (a) though (d) ranges from at least 0.003 to at most 0.1.

6. The foam of claim 1 wherein the foam is free of water-soluble polymer.

7. The foam of claim 1 wherein the ratio of the weight of polyolefin to the sum of the weights of components (a) though (d) is at least 0.6.

8. The foam of claim 1 wherein the foam has a density of at most 3 pounds/cubic foot.

9. The foam of claim 1 wherein:
the foam density is at most 3 pounds/cubic foot; and
the ratio of A to B is at least 0.04 and at most 0.22.

10. The foam of claim 1 configured as a plank having a thickness of at least 1 inch.

11. The foam of claim 1 configured as a sheet having a thickness of at most 0.2 inches.

12. A process for making the foam of claim 1 comprising:
providing the starch, the plasticizer, the compatibilizer, the polyolefin, and a physical blowing agent to an extruder;
mixing the starch, plasticizer, compatibilizer, polyolefin, and physical blowing agent in the extruder to form a mixture; and
expanding the mixture to form the foam as the mixture exits the extruder.

13. The process of claim 12 wherein at least a portion of the starch, plasticizer, and compatibilizer are mixed together before the providing step.

14. The process of claim 12 wherein at least a portion of the starch, plasticizer, compatibilizer, and polyolefin are mixed together before the providing step.

15. The process of claim 12 wherein the physical blowing agent comprises a hydrocarbon blowing agent.
